(19) United States
(12) Patent Application Publication
(10) Pub. No.: US 2025/0259147 A1
(43) Pub. Date: Aug. 14, 2025

(54) PREDICTIVE MAINTENANCE OF DOOR

(71) Applicant: ASSA ABLOY AB, Stockholm (SE)

(72) Inventors: Lars Lindroth, Hässelby (SE); Tomas Jonsson, Rönninge (SE); Anders Sahlström, Stockholm (SE)

(21) Appl. No.: 18/856,978

(22) PCT Filed: Apr. 13, 2023
(86) PCT No.: PCT/EP2023/059649

§ 371 Date: Oct. 15, 2024

(30) Foreign Application Priority Data
Apr. 19, 2022 (SE) 2250470-8

(51) Int. Cl. G06Q 10/20; G01D 5/14

(52) U.S. Cl. CPC G06Q 10/20; G01D 5/14

(57) ABSTRACT

It is provided a method for determining when to perform maintenance of a door (15). The method is performed by a maintenance determiner (1). The method comprises: obtaining (40), from a first sensor (6), sensor data indicating kinetic performance of the door: defining (42) a start time of the sensor data based on a first event detected by a second sensor (7), to enable synchronisation of the sensor data: dividing (46) the sensor data in a plurality of time periods (24a-c): evaluating (48) the sensor data in each one of the plurality of time periods by comparing to reference data respectively associated with each one of the plurality of time periods; and determining (50) to perform maintenance, based on the evaluation of the sensor data.

### TECHNICAL FIELD

The present disclosure relates to the field of doors where maintenance may be needed and in particular to a system for predictively determining when to perform maintenance of a door.

### BACKGROUND

There are several different types of doors, including rolling doors, sliding doors, and swing doors. Some of these doors are mechanically quite complicated, comprising door openers, door closers, sliding mechanisms, etc. Mechanical components of such doors wear over time or can be subject to failure due to external impact, and then require maintenance. In the prior art, maintenance on automatic doors is typically performed after failure has occurred, whereby the experiences a period of a non-operative, or less than normal operative state.

It would be a great improvement if an indication of maintenance can be provided when door is likely to fail, but before it has actually happened, i.e. adaptive predictive maintenance. Additionally, it would be of even greater use if a device for such a maintenance indication can be retrofit to existing doors in the field.

### SUMMARY

One object is to predictively determine when maintenance of a door is needed.

According to a first aspect, it is provided a method for determining when to perform maintenance of a door. The method is performed by a maintenance determiner. The method comprises: obtaining, from a first sensor, sensor data indicating kinetic performance of the door; defining a start time of the sensor data based on a first event detected by a second sensor, to enable synchronisation of the sensor data; dividing the sensor data in a plurality of time periods; evaluating the sensor data in each one of the plurality of time periods by comparing to reference data respectively associated with each one of the plurality of time periods; and determining to perform maintenance, based on the evaluation of the sensor data.

The first event may be a start of a door movement, wherein the door movement is a closing of the door or an opening the door.

The reference data may be selected based on whether the door movement is a closing of the door or an opening of the door.

The method may further comprise: defining an end time of the sensor data based on a second event detected by the second sensor.

The second event may be an end of the door movement.

The time periods may be defined as a preconfigured number of time periods of equal duration between the start time and the end time.

The time periods may be defined as a preconfigured number of time periods with a preconfigured duration from the start time.

The second sensor may be a magnetometer provided on one of the door and the door frame, configured to detect a magnetic field from a magnet provided on the other of the door and the door frame.

The first event may be detected based on detecting a first magnetic polarity and the second event may be based on detecting a second magnetic polarity being the opposite of the first magnetic polarity.

The second sensor may be a proximity sensor configured to detect when the door is in an open or closed position in relation to the door frame.

The first sensor may comprise an accelerometer.

The first sensor may comprise a sound sensor.

The evaluating the sensor data may be based on a machine learning model wherein each the sensor data in each time period is a separate input feature.

According to a second aspect, it is provided a maintenance determiner for determining when to perform maintenance of a door. The maintenance determiner comprises: a processor; and a memory storing instructions that, when executed by the processor, cause the maintenance determiner to: obtain, from a first sensor, sensor data indicating kinetic performance of the door; define a start time of the sensor data based on a first event detected by a second sensor, to enable synchronisation of the sensor data; divide the sensor data in a plurality of time periods; evaluate the sensor data in each one of the plurality of time periods by comparing to reference data respectively associated with each one of the plurality of time periods; and determine to perform maintenance, based on the evaluation of the sensor data.

The first event may be a start of a door movement, wherein the door movement is a closing of the door or an opening the door.

The reference data may be selected based on whether the door movement is a closing of the door or an opening of the door.

The maintenance determiner may further comprise instructions that, when executed by the processor, cause the maintenance determiner to: define an end time of the sensor data based on a second event detected by the second sensor.

The second event may be an end of the door movement.

The time periods may be defined as a preconfigured number of time periods of equal duration between the start time and the end time.

The time periods may be defined as a preconfigured number of time periods with a preconfigured duration from the start time.

The second sensor may be a magnetometer provided on one of the door and the door frame, configured to detect a magnetic field from a magnet provided on the other of the door and the door frame.

The first event may be detected based on detecting a first magnetic polarity and the second event may be based on detecting a second magnetic polarity being the opposite of the first magnetic polarity.

The second sensor may be a proximity sensor configured to detect when the door is in an open or closed position in relation to the door frame.

The first sensor may comprise (or be) an accelerometer.

The first sensor may comprises (or be) a sound sensor.

The instructions to evaluate the sensor data may comprise instructions that, when executed by the processor, cause the maintenance determiner to evaluate the sensor data based on a machine learning model wherein each the sensor data in each time period is a separate input feature.

According to a third aspect, it is provided a computer program for determining when to perform maintenance of a door. The computer program comprises computer program code which, when executed on a maintenance determiner causes the maintenance determiner to: obtain, from a first sensor, sensor data indicating kinetic performance of the door; define a start time of the sensor data based on a first event detected by a second sensor, to enable synchronisation of the sensor data; divide the sensor data in a plurality of time periods; evaluate the sensor data in each one of the plurality of time periods by comparing to reference data respectively associated with each one of the plurality of time periods; and determine to perform maintenance, based on the evaluation of the sensor data.

According to a fourth aspect, it is provided a computer program product comprising a computer program according to the third aspect and a computer readable means comprising non-transitory memory in which the computer program is stored.

According to a fifth aspect, it is provided a method for determining when to perform maintenance of a door. The method is performed by a maintenance determiner. The method comprises: obtaining, from a first sensor, sensor data indicating a condition of the door; defining a capture time of the sensor data based on a first event detected by a second sensor, to enable synchronisation of the sensor data; evaluating the sensor data; and determining to perform maintenance, based on the sensor data.

The first sensor may be configured to measure an indication of distance between two points of a spring of the door.

The first sensor may comprise at least one of a radar, a lidar, a laser, a capacitive sensor and an inductive sensor.

The first sensor may be configured to detect deterioration of a flexible force member.

The flexible force member may be a wire, chain or belt.

The first sensor may be a camera and wherein the sensor data comprises at least one image. In this case, the evaluating sensor data is based on image analysis of the sensor data.

According to a sixth aspect, it is provided maintenance determiner for determining when to perform maintenance of a door. The maintenance determiner comprises: a processor; and a memory storing instructions that, when executed by the processor, cause the maintenance determiner to: obtain, from a first sensor, sensor data indicating a condition of the door; define a capture time of the sensor data based on a first event detected by a second sensor, to enable synchronisation of the sensor data; evaluate the sensor data; and determine to perform maintenance, based on the sensor data.

The first sensor may be configured to measure an indication of distance between two points of a spring of the door.

The first sensor may comprise at least one of a radar, a lidar, a laser, a capacitive sensor and an inductive sensor.

The first sensor may be configured to detect deterioration of a flexible force member.

The flexible force member may be a wire, chain or belt.

The first sensor may be a camera and wherein the sensor data comprises at least one image. In this case, the instructions to evaluate the sensor data comprise instructions that, when executed by the processor, cause the maintenance determiner to evaluate sensor data is based on image analysis of the sensor data.

According to a seventh aspect, it is provided a computer program for determining when to perform maintenance of a door. The computer program comprises computer program code which, when executed on a maintenance determiner causes the maintenance determiner to: obtain, from a first sensor, sensor data indicating a condition of the door; define a capture time of the sensor data based on a first event detected by a second sensor, to enable synchronisation of the sensor data; evaluate the sensor data; and determine to perform maintenance, based on the sensor data.

According to an eighth aspect, it is provided a computer program product comprising a computer program according to the seventh aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIGS. 2A-B are schematic diagrams illustrating how the second sensor of FIG. 1 can be used for synchronising sensor data according to one embodiment where the second sensor is mounted to the door;

FIGS. 3A-B are schematic diagrams illustrating how the second sensor of FIG. 1 can be used for synchronising sensor data according to one embodiment where the second sensor is mounted in the surrounding structure;

FIG. 4 is a schematic graph illustrating how the sensor data is divided into time periods according to one embodiment;

FIG. 5 is a flow chart illustrating embodiments of methods for determining when to perform maintenance of a door;

FIG. 6 is a schematic diagram illustrating components of the maintenance determiner of FIG. 1; and

FIG. 7 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

Embodiments presented herein are based on the realisation that sensor data from a first sensor of a door, detecting kinematic aspects of the door, can be used to determine when maintenance is needed. A second sensor can be used to synchronise the sensor data across instances of sensor data. The sensor data is split into time periods and is evaluated for each one of the time periods. In this way, deviations in the sensor data can be found, and since the sensor data is synchronised, accurate determination can be made without the need to connect to internal control (e.g. motor control or sensors) of the door system. Hence, this maintenance determination can easily be retrofit to an existing door system.

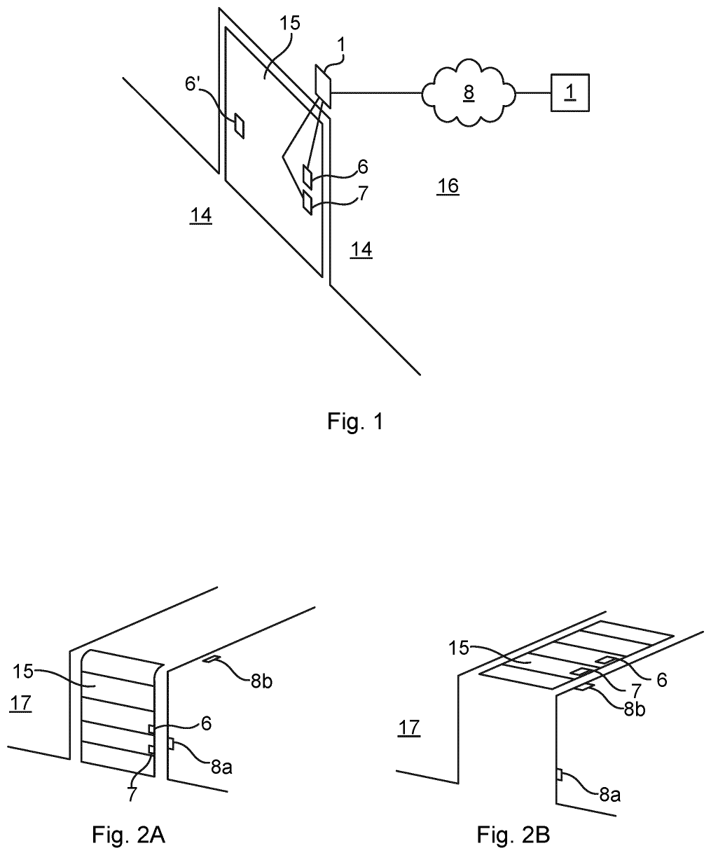

FIG. 1 is a schematic diagram illustrating an environment in which embodiments presented herein can be applied. Access to a physical space 16 is restricted by an openable physical door 15. The door 15 stands between a first physical space 14 and the second physical space 16. The door 15 can be any type of door, including a roller door, a sliding door, a swing door, etc. Optionally, the door 15 comprises a door opener and/or door closer to control opening and/or closing of the door 15. Optionally, an electronic lock (not shown) is provided in order to control access to the second physical space 16, by selectively unlocking the door 15 based on provided credential (such as a key fob, smartphone or PIN). The door 15 is provided in an opening in a surrounding structure 17 (such as a wall) that surrounds the door 15.

According to embodiments presented herein, a first sensor 6 is provided to obtain sensor data that indicates kinetic performance of the door 15. In other words, the characteristics of movement (e.g. vibrations, sound, and/or visual characteristics) of the door 15 are captured in sensor data obtained by the first sensor 6. The sensor data thereby captures aspects of kinetic performance of the door 15 during door opening and/or door closing. The first sensor 6 can be mounted on the door 15 itself (as shown) or the first sensor 6 can be mounted to the surrounding structure 17 (not shown). The first sensor 6 can e.g. comprise an accelerometer. Alternatively or additionally, the first sensor can comprise a sound sensor, such as a microphone. Alternatively or additionally, the first sensor 6 comprises or is an image capturing device, e.g. a camera, a matrix-based time-of-flight sensor, a radar, a lidar, etc.

A second sensor 7 is provided to enable synchronisation of sensor data (in relation to door opening or door closing) across instances of sensor data. More elaborate embodiments of the second sensor 7 are shown in FIGS. 2A-B and are explained below.

The sensor data from the first sensor 6 is provided to a maintenance determiner 1. The maintenance determiner 1 evaluates the sensor data, as explained in more detail below, to determine when to perform maintenance of the door 15.

The maintenance determiner 1 can be provided locally, at the site of the door 15. Alternatively or additionally, the maintenance determiner 1 is provided remotely (also known as in the cloud), connected to the first sensor 6 and second sensor 7 via a communication network 8, which can be an internet protocol (IP)-based network. The communication network 8 can e.g. comprise any one or more of a local wireless network, a cellular network, a wired local-area network, a wide-area network (such as the Internet), etc. Optionally, part of the maintenance determiner 1 is provided locally and part of the maintenance determiner 1 is provided remotely, in communication with each other, as long as the maintenance determiner supports the embodiments presented herein.

FIGS. 2A-B are schematic diagrams illustrating how the second sensor 7 of FIG. 1 can be used for synchronising sensor data according to one embodiment. The second sensor 7 is provided on the door and at least one magnet 8a, 8b is provided mounted to the surrounding physical structure. In the illustrated embodiments, there is a first magnet 8a and a second magnet 8b. The door 15 is here a roller door. A motor (not shown) can be controlled to open and/or close the door 15. In this embodiment, the second sensor 7 is a magnetometer and there are two magnets 8a, 8b.

Looking to the scenario illustrated by FIG. 2A, the door 15 is here in a closed state. The second sensor 7 (magnetometer) is near the first magnet 8a. This results in a strong magnetic field that is detected by the second sensor 7. Optionally, the first magnet 8a is provided offset along a direction of door movement of the second sensor 7 when the door 15 is opened. In this way, when the door 15 opens, a first event of a peak of the magnetic field, measured by the second sensor 7, can be detected predictably and reliably every time the door is opened at the same stage of opening, just after the opening starts.

Looking to the scenario illustrated by FIG. 2B, the door 15 is here in an opened state. The second sensor 7 (magnetometer) is near the second magnet 8b. This results in a strong magnetic field that is detected by the second sensor 7. Optionally, the second magnet 8b is provided offset along a direction of door movement of the second sensor 7 when the door 15 is closed. In this way, when the door 15 closes, a second event of a peak of the magnetic field, measured by the second sensor 7, can be detected predictably and reliably every time the door is closed at the same stage of closing, just after the closing starts.

Optionally, the first magnet 8a and the second magnet 8b are provided such that they result in opposite magnetic polarities in the direction of the passing second sensor 7. This allows the identification of the magnet 8a-b that the second sensor 7 passes by when the door movement starts. Hence, when the door movement starts, by detecting the polarity of the first magnetic field measured by the second sensor 7, it can be determined whether the motion is a closing door movement (in which case the polarity of the first magnet 8a is detected) or the motion is an opening door movement (in which case the polarity of the second magnet 8b is detected). This results in reliable detection of both the type of door movement and the determination of a start time (the first event) for sensor data captured for the door movement.

Optionally, both magnets are used to determine both the start time (the first event) and an end time (a second event) for the sensor data. For instance, in an opening door movement, the time of detecting the peak of the magnetic field from the first magnet 8a defines the start time and the time of detecting the peak of the magnetic field from the second magnet 8b defines the end time. Analogously, in a closing door movement, the time of detecting the peak of the magnetic field from the second magnet 8b defines the start time and the time of detecting the peak of the magnetic field from the first magnet 8a defines the end time.

In the embodiments of FIGS. 2A-B, the magnets 8a-b are fixedly mounted in the surrounding structure 17 and the second sensor 7 is mounted to the door 15.

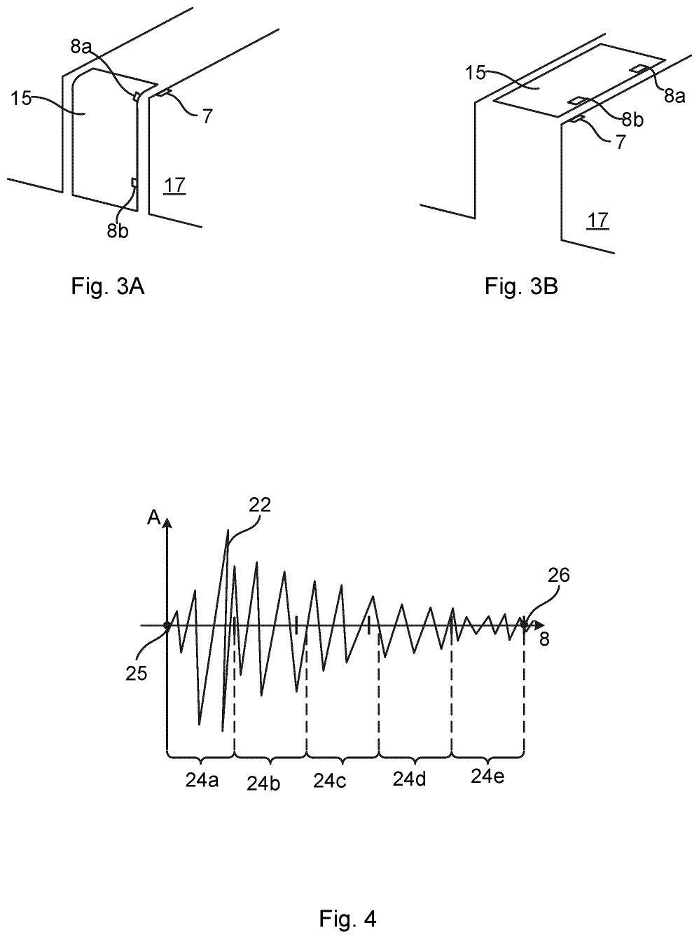

FIGS. 3A-B are schematic diagrams illustrating how the second sensor 7 of FIG. 1 can be used for synchronising sensor data according to one embodiment where the second sensor is mounted in the surrounding structure 17. In the embodiments of FIGS. 3A-B, the magnets 8a-b are mounted to the door 15 and the second sensor 7 is fixedly mounted to the surrounding structure 17.

The function of the embodiments of FIGS. 3A-B is the same as that for the embodiments of FIGS. 2A-B. Specifically, at the start of an opening door movement, the fixed sensor 7 detects the magnetic field peak caused by the first magnet 8a and at the end of the opening door movement, the fixed sensor 7 detects the magnetic field caused by the second magnet 8b, and vice versa for the closing door movement.

FIG. 4 is a schematic graph illustrating how the sensor data 22 is divided into time periods according to one embodiment. The vertical axis represents amplitude of sensor data (e.g. acceleration in one dimension) and the horizontal axis represents time. It is to be noted that, when the sensor data is based on an accelerometer, there can be corresponding sensor data for the other two dimensions. Each dimension then contains data that can be evaluated in the same way, divided into time periods as presented below.

A start time 25 defines the start of the sensor data 22 and an end time 26 defines the end of the sensor data 22 to be evaluated. It is to be noted that there may data available after the end time 26 or before the start time 25, but such data is not evaluated according to embodiments presented herein.

The end time 26 can be determined by the second sensor 7, e.g. as explained above with reference to FIGS. 2A-B and FIGS. 3A-B above. Alternatively, the end time 26 is at a pre-configured fixed duration after the start time 25.

The time between the start time 25 and the end time 26 is split into a plurality of time periods 24a-e. The time periods can be of the same length. Each time period can have a preconfigured length, in the case when the end time 26 is a preconfigured fixed duration after the start time 25.

Alternatively, when the end time 26 is dynamically determined, e.g. using the second sensor 7 as explained above, the time periods are defined as a preconfigured number of time periods between the start time and the end time. It is to be noted that there may be slight variations (e.g. +−5%) of the duration between the time periods 24a-e.

It is to be noted that the sensor data can relate to a complete opening door movement, or a complete closing door movement.

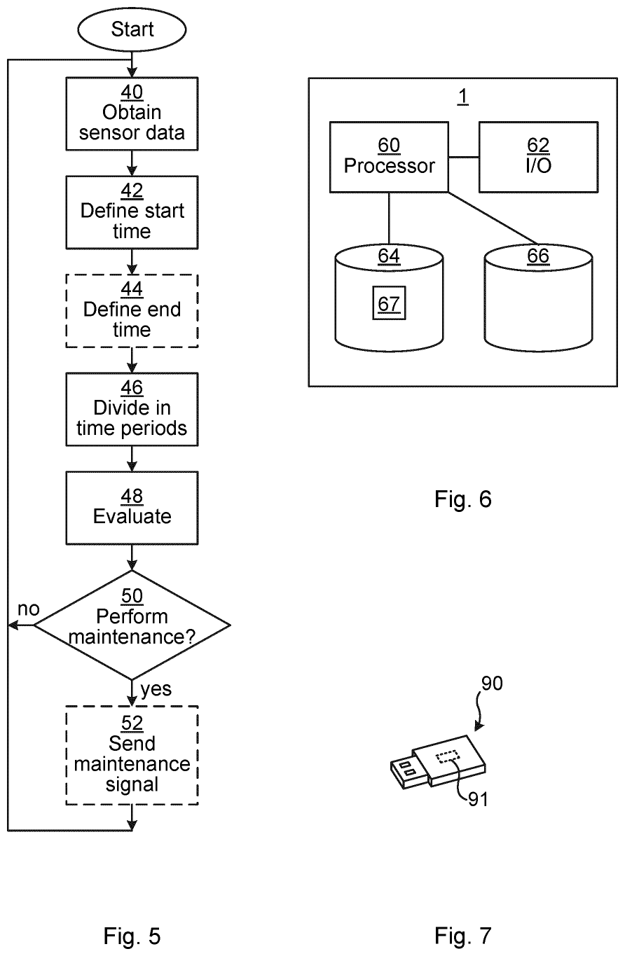

FIG. 5 is a flow chart illustrating embodiments of methods for determining when to perform maintenance of a door 15. The method is performed by the maintenance determiner.

In an obtain sensor data step 40, the maintenance determiner 1 obtains, from a first sensor 6, sensor data indicating kinetic performance of the door. The first sensor can be mounted to the door 15 or to a surrounding structure (e.g. wall) in the vicinity of the door 15. Alternatively, the first sensor 6 is mounted to the door frame, rails or springs of a door opening mechanism, etc. Optionally, the first sensor can be set in either one of a low-power mode and an active mode, where the low-power mode can be used for the large majority of time to save power. When the first sensor 6 is in the low-power mode, sampling can occur at a lower rate, e.g. 10-20 Hz and in the active mode, sampling can occur at a higher rate, e.g. 1-2 kHz.

The first sensor 6 can comprise or be an accelerometer, e.g. a three-dimensional (3D) accelerometer.

Alternatively or additionally, the first sensor 6 comprises or is a sound sensor, such as a microphone. The sound sensor can be configured to detect sound in the audible frequency range and/or in an ultrasound frequency range. The sound can be used to detect the need for maintenance. A broken or worn door often makes sounds that a normal smooth-moving door does not.

Alternatively or additionally, the first sensor 6 is configured to measure an indication of distance between two points of a spring of the door. In this way, if the spring wears over time leading to an elongation or a shortening of the spring, this is detected by the first sensor. The distance measurement can be achieved by the first sensor 6 comprising at least one of a radar, a lidar, a laser, a capacitive sensor and an inductive sensor. The two points of the spring can be a first point that is fixed in relation to the first sensor (e.g. an end point of the spring) and a second point that moves when the door moves. In this way, the measurement of distance (between the first sensor and the second point) is indicative of a distance between the two points of the spring.

Alternatively or additionally, the first sensor 6 is configured to detect deterioration of a flexible force member of the door, such as a wire, chain or belt. The flexible force member can be used to pull an end of the door (against gravity or other counterforce) to a desired position, e.g. open position or closed position. In this case, the first sensor 6 can be a camera, whereby the sensor data comprises at least one image.

One possibility is also to only send a small part of the sound to a central location, where the sound can be elongated to improve the ability of a service technician to hear details in the sound, to thereby identify the event.

The sound sensor might not be used every time, to reduce power use. For instance, the sound sensor can be configured to be used only when the accelerometer is not sufficiently accurate in its detection. The accelerometer can also be used to detect a suspected change in operation, that can be verified using the sound sensor.

Optionally, the sound can be recorded and transmitted to a central location for evaluation, using AI (Artificial Intelligence) or manually by a service technician. The sound data can be compressed prior to transmission. Furthermore, the start and end time of the sound can be determined by the local device to capture the relevant section of sound. Optionally, the accelerometer and the sound sensor can be separate devices.

Alternatively or additionally, the first sensor 6 comprises or is an image capturing device, e.g. a camera, a matrix-based time-of-flight sensor, a radar, lidar, etc.

In a define start time step 42, the maintenance determiner 1 defines a start time of the sensor data based on a first event detected by a second sensor 7. The start time enables synchronisation of the sensor data. The synchronisation can be used to align the start time of the sensor data for comparison with reference sensor data, such that the start time of the of the sensor data is consistent across instances of sensor data.

The first event can be a start of a door movement, wherein the door movement is a closing of the door or an opening the door. The reference data can be selected based on whether the door movement is a closing of the door or an opening of the door. In this way, the reference data is specific for door closing or door opening, which can vary significantly in its kinetic characteristics.

The second sensor can be a magnetometer provided on one of the door and the door frame, configured to detect a magnetic field from a magnet provided on the other of the door and the door frame. The first event can be detected based on detecting a first magnetic polarity and a second event can be based on detecting a second magnetic polarity being the opposite of the first magnetic polarity. The second event can be an end of the door movement. Embodiments of the magnets and magnetometer are illustrated by FIGS. 2A-B and FIGS. 3A-B and are described above.

In one embodiment, the second sensor 7 is a proximity sensor configured to detect when the door 15 is in an open or closed position in relation to the door frame. The proximity sensor can be mounted to the door frame, and can detect when there is an adjacent door or not. One proximity sensor can be provided in a position such that it signals door presence only when the door is fully closed, i.e. at the end of the door closing. Another proximity sensor can be provided in a position such that it signals door absence only when the door is fully opened, i.e. at the end of the door opening.

In one embodiment, the second sensor is a radar that is configured to detect the state of the door 15.

When the first sensor 6 is used to measure an indication of distance between two points of the spring, or the first sensor 6 is used to detect deterioration of the flexible force member, instead of determining a start time, this step comprises defining a capture time of the sensor data based on the first event detected by a second sensor, to enable synchronisation of the sensor data. The capture time of the sensor data is thus consistent over instances of door movement.

In an optional define end time step 44, the maintenance determiner 1 defines an end time of the sensor data based on the second event detected by the second sensor.

In a divide in time periods step 46, the maintenance determiner 1 divides the sensor data in a plurality of time periods 24a-e. The time periods are defined as a preconfigured number of time periods with a preconfigured duration from the start time. This embodiment is not so sensitive regarding the speed of the door, but rather of the kinetics within each time period of the opening or closing door movement.

Alternatively, the time periods can be defined as a preconfigured number of time periods of equal duration between the start time and the end time. This embodiment is sensitive if the door movement slows down over time.

In an evaluate step 48, the maintenance determiner 1 evaluates the sensor data in each one of the plurality of time periods by comparing to reference data respectively associated with each one of the plurality of time periods.

This can be an explicit comparison, e.g. by calculating a variation value and/or energy value within each time period and comparing with reference values for each time period. The reference data can be obtained by a calibration procedure when the door is installed, or otherwise is in a known normal operating state (e.g. after the door has been repaired/maintained). In the calibration procedure, the maintenance determiner is set in a calibration mode, and the door is opened and closed at least a set number of times. An average of values, such as variation values and/or energy values, are calculated for each time period, which thus makes up the reference data and the calibration is finished.

Alternatively, the comparison is implicit and is based on a machine learning model wherein the sensor data in each time period is a separate input feature. The machine learning model can be trained in a similar manner to the calibration mentioned above. The training is performed when the door is installed, or otherwise is in a known normal operating state (e.g. after the door has been repaired/maintained). In the training procedure, the maintenance determiner is set in a training mode, and the door is opened and closed at least a set number of times. The training data is explicitly or implicitly labelled to be a normal operation state for the door. The features for the training are based on the time periods defined according to the above.

Regardless of whether the evaluation is based on comparison with set values or if it is based on machine learning, the reference data is specific for the door and its kinematic and static environment. Consequently, the evaluation does not rely on any prior knowledge of vibrations/sound/visual data of how the door should perform. This results in an evaluation that is tailored to each door installation, regardless of its door type or whether it is installed in a stud wall, concrete wall, steel beam presence, etc. Hence, the maintenance determiner 1 can easily be retrofit to an existing door installation, regardless of installation particulars and does not need to be connected to any motor control signal or preinstalled door sensors, etc., that may differ significantly from installation to installation.

Moreover, by performing the evaluation based on each time period separately, a more robust evaluation is achieved compared to if the evaluation were to be performed on comparing graphs or similar. To achieve good accuracy, specific kinetic patterns are thus located in the same time period, aligned to when opening or closing occurs, in the sensor data and reference data.

In the embodiment when the first sensor measures distance between the two points of the spring of the door, the evaluation of the sensor data comprises determining whether the spring has elongated or shortened over time. The reference distance for this determination can be set when the door is installed, or can be set during production. In this way, deteriorating performance of the door due to spring wear is detected, and the spring can be replaced before the operation of the door is significantly affected by the worn spring. In this embodiment, the divide in time periods step 46 does not need to be performed.

In the embodiment when the first sensor detects deterioration of the flexible force member, the evaluation of sensor data comprises is based on image analysis of the sensor data. The image can e.g. capture fraying of a belt or wire, or indication of any beginning breakage of a link of chain. This allows a maintenance operator to replace the flexible force member prior to the operation of the door being significantly affected by the worn flexible force member. In this embodiment, the divide in time periods step 46 does not need to be performed.

In a conditional perform maintenance step 50, the maintenance determiner 1 determines when to perform maintenance, based on the evaluation of the sensor data. For instance, when the calculated values differ more than a threshold from the reference values or the machine learning model signals a deviation, this can result in a determination that maintenance is to be performed. When maintenance is determined to be performed, the method proceeds to a send maintenance signal step 52. Otherwise, the method returns to the obtain sensor data step 40.

In the optional send maintenance signal step 52, the maintenance determiner 1 sends a maintenance signal, indicating that maintenance of the door is recommended. The maintenance signal can e.g. be transmitted to an operation and maintenance system or as a text message or e-mail message to a preconfigured recipient.

In one embodiment, the maintenance determiner 1 comprises a camera which can be used to capture the reason for an impact which causes damage to the door. The reason for the impact can e.g. a truck or trolley ramming into the door. An accelerometer of the maintenance determiner can then be used as a filter of continuous video data from the camera, whereby video data is only saved in long-term storage in conjunction to when the accelerometer detects an acceleration of a particular magnitude and/or pattern. In this case video data x seconds before and y seconds after the impact can be stored in long-term storage, where x and y are configurable parameters. Optionally, the accelerometer can be used to detect where the impact occurs.

When a sound sensor is provided, the sound detection is optionally triggered by accelerometer data indicating external impact from an object or other deviation from normal. The accelerometer can optionally wake up the sound sensor in this case. The sound can help to provide better classification of the event.

The embodiments presented herein can be retrofit with simple sensors and do not require to be connected to motor controls or integral sensors in door mechanisms.

FIG. 6 is a schematic diagram illustrating components of the maintenance determiner 1 of FIG. 1. A processor 60 is provided using any combination of one or more of a suitable central processing unit (CPU), graphics processing unit (GPU), multiprocessor, microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIG. 5 above.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

The maintenance determiner 1 further comprises an I/O interface 62 for communicating with external and/or internal entities. Optionally, the I/O interface 62 also includes a user interface.

An I/O interface 62 is provided for communicating with external and/or internal entities (including the first sensor 6 and the second sensor 7) using wired communication, e.g. based on Ethernet, and/or wireless communication, e.g. Wi-Fi, and/or a cellular network, complying with any one or a combination of next generation mobile networks (fifth generation, 5G), LTE (Long Term Evolution), UMTS (Universal Mobile Telecommunications System) utilising W-CDMA (Wideband Code Division Multiplex), or any other current or future wireless network, as long as the principles described hereinafter are applicable.

Other components of the maintenance determiner 1 are omitted in order not to obscure the concepts presented herein.

FIG. 7 shows one example of a computer program product 90 comprising computer readable means. On this computer readable means, a computer program 91 can be stored in a non-transitory memory. The computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 6. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1-30. (canceled)

31. A method for determining when to perform maintenance of a door, the method being performed by a maintenance determiner, the method comprising:
performing a calibration procedure for the door to obtain reference data for the door;
obtaining, from a first sensor, sensor data indicating kinetic performance of the door;
defining a start time of the sensor data based on a first event detected by a second sensor, to enable synchronisation of the sensor data;
dividing the sensor data in a plurality of time periods;
evaluating the sensor data in each one of the plurality of time periods by comparing to the reference data respectively associated with each one of the plurality of time periods; and
determining to perform maintenance based on the evaluation of the sensor data.

32. The method of claim 31, wherein the first event is a start of a door movement, wherein the door movement is a closing of the door or an opening the door.

33. The method of claim 32, wherein the reference data is selected based on whether the door movement is a closing of the door or an opening of the door.

34. The method of claim 31, further comprising defining an end time of the sensor data based on a second event detected by the second sensor.

35. The method of claim 32, further comprising defining an end time of the sensor data based on a second event detected by the second sensor, wherein the second event is an end of the door movement.

36. The method of claim 34, wherein the plurality of time periods are defined as a preconfigured number of time periods of equal duration between the start time and the end time.

37. The method of claim 31, wherein the plurality of time periods are defined as a preconfigured number of time periods with a preconfigured duration from the start time.

38. The method of claim 31, wherein the second sensor is a magnetometer, provided on one of the door or the door frame, configured to detect a magnetic field from a magnet provided on the other of the door or the door frame.

39. The method of claim 34, wherein:
the second sensor is a magnetometer, provided on one of the door or the door frame, configured to detect a magnetic field from a magnet provided on the other of the door or the door frame;
the first event is detected based on detecting a first magnetic polarity; and
the second event is based on detecting a second magnetic polarity being opposite the first magnetic polarity.

40. The method of claim 31, wherein the second sensor is a proximity sensor configured to detect when the door is in an open or closed position in relation to a door frame.

41. The method of claim 31, wherein the first sensor comprises an accelerometer.

42. The method of claim 31, wherein the first sensor comprises a sound sensor.

43. The method of claim 31, wherein evaluating the sensor data is based on a machine learning model wherein the sensor data in each one of the plurality of time periods is a separate input feature.

44. A maintenance determiner for determining when to perform maintenance of a door, the maintenance determiner comprising:
a processor; and
a memory storing instructions that, when executed by the processor, cause the maintenance determiner to:
perform a calibration procedure for the door to obtain reference data for the door;
obtain, from a first sensor, sensor data indicating kinetic performance of the door;
define a start time of the sensor data based on a first event detected by a second sensor, to enable synchronisation of the sensor data;
divide the sensor data in a plurality of time periods;
evaluate the sensor data in each one of the plurality of time periods by comparing to the reference data respectively associated with each one of the plurality of time periods; and
determine to perform maintenance based on the evaluation of the sensor data.

45. The maintenance determiner of claim 44, wherein the first event is a start of a door movement, wherein the door movement is a closing of the door or an opening the door.

46. The maintenance determiner of claim 45, wherein the reference data is selected based on whether the door movement is a closing of the door or an opening of the door.

47. The maintenance determiner of claim 44, wherein the instructions further cause the maintenance determiner to define an end time of the sensor data based on a second event detected by the second sensor.

48. The maintenance determiner of claim 45, wherein the instructions further cause the maintenance determiner to define an end time of the sensor data based on a second event detected by the second sensor, wherein the second event is an end of the door movement.

49. The maintenance determiner of claim 47, wherein the plurality of time periods are defined as a preconfigured number of time periods of equal duration between the start time and the end time.

50. A non-transitory computer readable medium storing a computer program for determining when to perform maintenance of a door, the computer program comprising computer program code which, when executed on a maintenance determiner, causes the maintenance determiner to:
perform a calibration procedure for the door to obtain reference data for the door;
obtain, from a first sensor, sensor data indicating kinetic performance of the door;
define a start time of the sensor data based on a first event detected by a second sensor, to enable synchronisation of the sensor data;
divide the sensor data in a plurality of time periods;
evaluate the sensor data in each one of the plurality of time periods by comparing to the reference data respectively associated with each one of the plurality of time periods; and
determine to perform maintenance based on the evaluation of the sensor data.
